(19) United States
(12) Patent Application Publication
(10) Pub. No.: US 2019/0091495 A1
(43) Pub. Date: Mar. 28, 2019

(54) AN ABSEILING DEVICE

(71) Applicant: Klaas Zwart, The Anchorage (GI)

(72) Inventor: Klaas Zwart, The Anchorage (GI)

(21) Appl. No.: 16/090,017

(22) PCT Filed: Mar. 20, 2017
(86) PCT No.: PCT/EP2017/056569

§ 371 Date: Sep. 28, 2018

(30) Foreign Application Priority Data
Mar. 31, 2016 (GB) 1605468.6

(51) Int. Cl. A62B 1/10; B65H 75/44

(52) U.S. Cl. CPC A62B 1/10; B65H 75/4471; B65H 75/4442

(57) ABSTRACT

An abseiling device includes an annular spool with an inner surface, the spool being rotatable around a central axis. The spool includes an annular gear around its periphery with gear teeth facing the central axis. A line is wound around the spool, with one end fixed to the spool and the other end having an attachment mechanism. The device also has a shaft which is co-axial with the central axis and a centrifugal brake attached to the shaft. The centrifugal brake includes brake pads for applying a breaking force to the spool. The device also has a brake gear attached to the shaft, the brake gear being rotatable with the shaft, and a compound gear. The compound gear includes a first gear for engaging with the brake gear and a second gear for engaging with the annular gear. The first gear has a greater number of teeth than the second gear. When the spool is at rest the brake pad extends around over 80% of the circumference of the inner surface of the spool.

### BACKGROUND OF THE INVENTION

### 1. The Field of the Invention

The present invention relates to a device for abseiling. In particular, it may be used by an individual to escape from a building in an emergency situation. For example, the device may be used to abseil from an above-ground level window in the case of a fire on a lower level. However, it may also be used recreationally, or for commercial purposes such as construction or maintenance work.

### 2. The Relevant Technology

Known abseiling devices are known, for example, in WO 2009/000015, which comprises a centrifugal brake mounted inside a rotating drum which is attached to an abseiling wire. As the wire is unwound, planetary gear system transfers the rotation to the centrifugal brake in order to slow the descent of a user. The system is approximately 12 inches in diameter.

### SUMMARY OF THE INVENTION

The present invention provides an abseiling device comprising: an annular spool with an inner surface, the spool being rotatable around a central axis, the spool comprising an annular gear around its periphery with gear teeth facing the central axis; a line wound around the spool, with one end fixed to the spool and the other end comprising attachment means; a shaft co-axial with the central axis; a centrifugal brake attached to the shaft comprising: brake pads for applying a breaking force to the spool; a brake gear attached to the shaft and rotatable with the shaft; a compound gear, comprising a first gear for engaging with the brake gear and a second gear for engaging with the annular gear, wherein the first gear has a greater number of teeth than the second gear and; wherein with the spool at rest the brake pad extends around over 80% of the circumference of the inner surface of the spool.

This allows for an abseiling device that is much smaller than have been known in the prior art as the same speed control may be achieved through the use of the compound gear.

In certain embodiments the compound gear further comprises a shaft attached to the first and second gears such that they rotate together, but preferably the first and second gears are formed as a single continuous compound gear to further miniaturise the device.

Preferably the first gear engages directly with the brake gear and the second gear engages directly with the annular gear for simplicity. However, there may be additional intermediate gears.

In certain embodiments with the spool at rest the brake pad extends around over 90% of the circumference of the inner surface of the spool. This ensures that a suitable breaking force can be applied to the spool.

In certain embodiments the ratio of the radius of the brake surface to the largest point of the drum spool is greater than 60%.

In certain embodiments the ratio of the radius of the brake surface to the largest point of the drum spool is greater than 70%.

In certain embodiments the compound gear extends past the largest point of the drum spool.

In certain embodiments the device further comprises: a housing for the components; and at least three bearings on each side of the housing in contact with an outer surface of the spool. These bearings support the spool in the housing and allow it to rotate.

### BRIEF DESCRIPTION OF THE DRAWINGS

The invention will now be described with reference to the accompanying drawings, in which:

FIG. 1 is an external view of an abseiling device according to the invention;

FIG. 2 is a view of an abseiling device according to the invention with the outer case front hidden;

FIG. 3 is a view of the gear assembly of an abseiling device according to the invention;

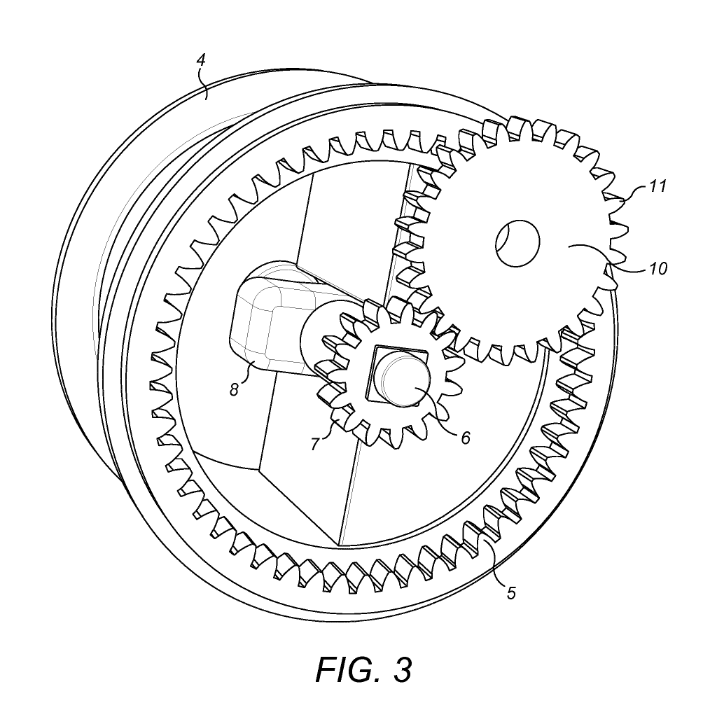

FIG. 4 is a rear view of the gear assembly of an abseiling device according to the invention;

FIG. 5 is a view of a single brake pad of an abseiling device according to the invention; and

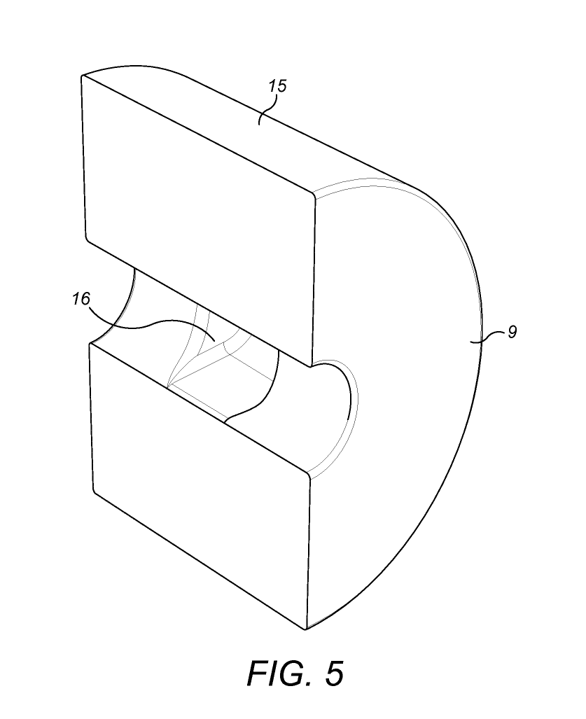

FIG. 6 is an exemplary drawing of a device according to the invention in use.

### DETAILED DESCRIPTION OF THE PREFERRED EMBODIMENTS

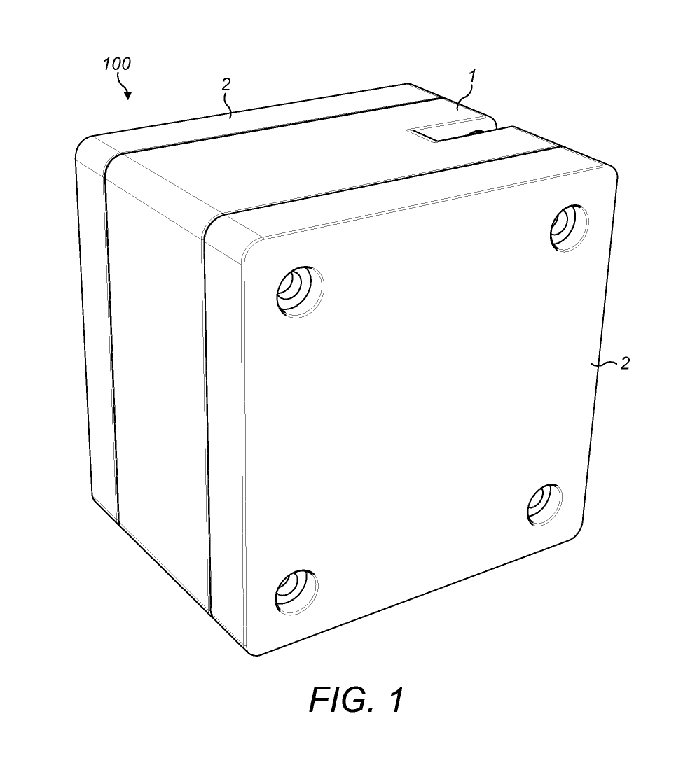

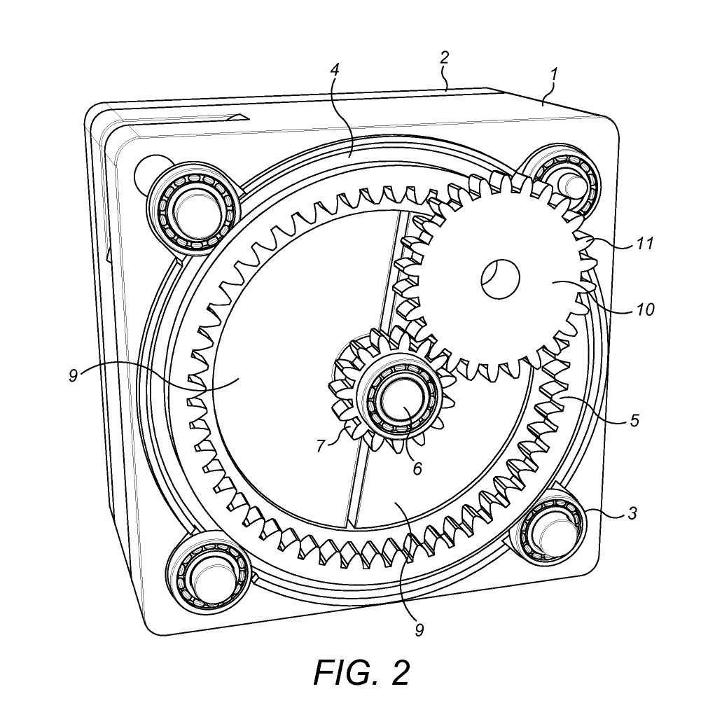

FIG. 1 shows an abseiling device 100, contained within a housing made up of central housing body 1 and first and second end plates 2. In FIG. 2, one of the end plates 2 is not shown. The abseiling device 100 comprises a drum spool 4, around which abseiling wire 21 is wound. A small hole is provided in the side of the drum spool 4 and the wire 21 is fed through this hole in order to attach the wire 21 to the spool 4. While the present embodiment uses wire 21 wound around the drum spool 4, rope or other suitable materials may also be used.

The drum spool 4 is supported within the housing body 1 by four bearings 3 which engage with an outer surface of an outer flange that extends substantially around the periphery of the drum spool 4. These bearings 3 allow the drum spool 4 to rotate within the housing body 1 around a central axis.

The drum spool 4 is hollow to form a cylindrical shell. Two brake pads 9 are located within the drum spool 4 for applying a breaking force to an inner surface of the drum spool 4.

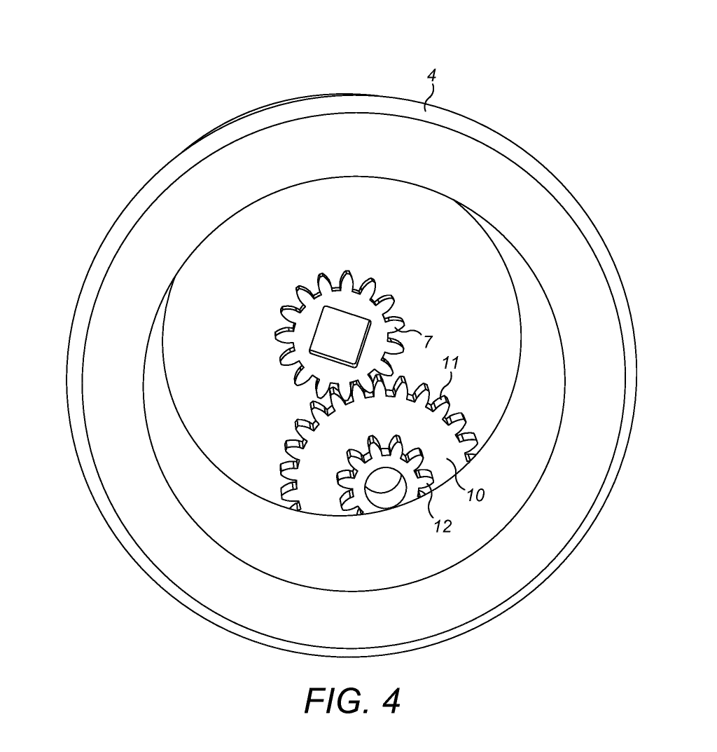

The drum spool 4 outer flange is provided with a series of inwardly facing gear teeth to form an annular gear 5. A compound gear 10 is provided, which consists of first outer gear 11 and second inner gear 12 (shown in FIG. 4). In the drawn embodiment the two gears are formed as a single compound gear 10, but they may instead be separate gears and attached to a common shaft to form a compound gear 10. The second gear 12 has fewer teeth than the first gear 11. The second gear 12 engages with the annular gear 5. The first gear 11 engages with a brake gear 7. There may be additional gears between the first gear 11 and the brake gear 7 and/or between the second gear 12 and the annular gear 5. In a preferred embodiment the first gear 11 engages directly with the brake gear 7 and/or the second gear 12 engages directly with the annular gear 5.

The brake gear 7 is attached to a shaft 6 such that the shaft 6 rotates with the brake gear 7. The shaft 6 is co-axial with the axis of rotation of the drum spool 4 and is also able to rotate around this axis. The shaft 6 is provided with driving member 8, which rotates with the shaft 6. The brake pads 9 each have a radial slot 16 in which the driving member 8 is located. The brake pads 9 are able to slide radially relative to the driving member 8. As the driving member 8 rotates, the brake pads 9 are in turn forced to rotate. The driving member 8 may be a separate component from the shaft 6 or may be formed integrally therewith.

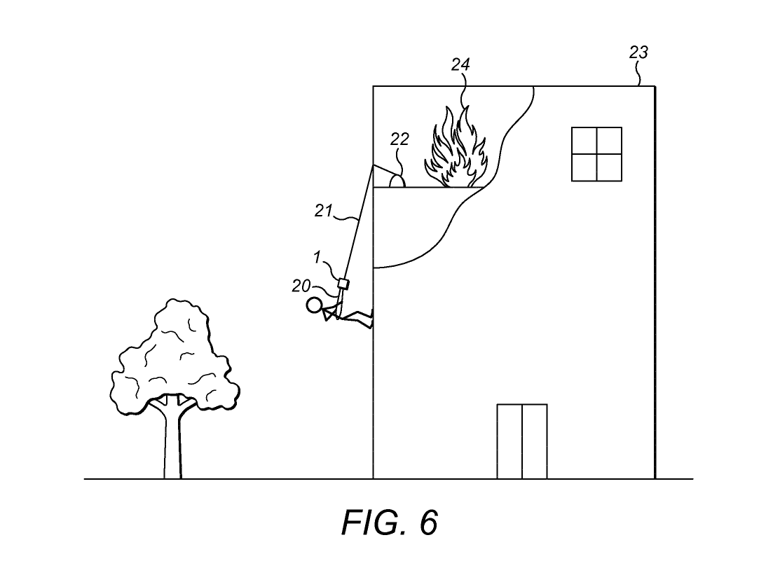

In use as shown in FIG. 6, a harness 20 is attached to the housing 1 and a user secures the harness 20 to themselves. In particular, the harness 20 may be a simple sling that extends underneath the user's armpits and around their chest. The loose end of the wire 21 is attached to an anchor point on the building 23 which is undergoing an emergency situation (in FIG. 6, this is represented by fire 24) and the user begins their descent. As the user descends, the wire 21 is wound off of the drum spool 4, through the housing 1 as the user is descending. This causes the drum spool 4 to begin to rotate as the wire 21 is unwound. Rotation of the drum spool 4 causes rotation of the compound gear 10 due to the engaged annular gear 5 and second gear 12. The rotation of the compound gear 10 is transferred to the shaft 6 via the engagement of the brake gear 7 and the first gear 11.

In a starting position, the brake pads 9 do not provide a braking force on the drum spool 4. As the shaft 6 begins to rotate, so does the driving member 8, and hence so do the brake pads 6. In the rotating reference frame, a centrifugal force is generated away from the axis of rotation on the brake pads 9. This forces the brake pads 9 away from the axis of rotation as they slide relative to the driving member 8 and engages their brake surfaces 15 with the inner surface of the drum spool 4. As the user descends faster, the rotation of the drum spool 4 is increased, which increases the centrifugal force of the brake pads 6. This leads to an increased braking force being generated.

As such, a terminal speed of descent will be reached wherein the user does not experience any more acceleration and may safely descend.

The compound gear of the present invention, wherein the first gear has a greater number of teeth than the second gear allows the required acceleration ratio between the drum and the centrifugal break to be achieved, whilst minimising the size of the device. In particular, this may be beneficial for emergency evacuation situations, as the small device may be safely stored and transported. The present embodiment results in a device capable of facilitating descent of 21 metres, or 7 floors, wherein the width, height and breadth of the housing are each less than 110 mm. A slightly larger device of less than 155 mm may allow descent of 60 metres, or 20 floors. Such a larger device may include multiple compound gears. Traditional systems may be up to 300 mm in size, which increases storage and weight requirements.

The brake pads extend around substantially the entire circumference of the bore of the drum spool 4. This is as the same breaking force can be generated as would be generated in a larger device which typically has less circumferential extension. In particular, the brake pad engages with over 80% of the circumference of the bore at rest. In a preferred embodiment, the brake pad may engage with over 90% of the circumference of the bore at rest.

The reduction in size is achieved by the use of the compound gear as this allows the radius of the drum spool to be reduced. The radius of the drum spool is constrained by the number of teeth on the annular gear, as a suitably large number of teeth are required to achieve a suitable descent rate. The use of the compound gear means that the same overall reduction in descent rate may be achieved with fewer annular teeth, and hence a smaller drum spool. In particular, the ratio of the radius of the brake surface 15 to the largest point of the drum spool is greater than 60%. Preferably, the ratio may be greater than 70%. In preferred embodiments, the compound gear 10 extends past the largest point of the drum spool.

1. An abseiling device comprising:
an annular spool with an inner surface, the spool being rotatable around a central axis, the spool comprising an annular gear around its periphery with gear teeth facing the central axis;
a line wound around the spool, with one end fixed to the spool and the other end comprising attachment means;
a shaft co-axial with the central axis;
a centrifugal brake attached to the shaft comprising:
brake pads for applying a breaking force to the spool;
a brake gear attached to the shaft and rotatable with the shaft;
a compound gear, comprising a first gear for engaging with the brake gear and a second gear for engaging with the annular gear,
wherein the first gear has a greater number of teeth than the second gear and;
wherein with the spool at rest the brake pad extends around over 80% of the circumference of the inner surface of the spool.

2. The abseiling device according to claim 1, wherein the first and second gears are formed as a single continuous compound gear.

3. The abseiling device according to claim 1, wherein the first gear engages directly with the brake gear.

4. The abseiling device according to claim 1, wherein the second gear engages directly with the annular gear.

5. The abseiling device according to claim 1, wherein with the spool at rest the brake pad extends around over 90% of the circumference of the inner surface of the spool.

6. The abseiling device according to claim 1, wherein the ratio of the radius of the brake surface to the largest point of the drum spool is greater than 60%.

7. The abseiling device according to claim 1, wherein the ratio of the radius of the brake surface to the largest point of the drum spool is greater than 70%.

8. The abseiling device according to claim 1, wherein the compound gear extends past the largest point of the drum spool.

9. The abseiling device according to claim 1, further comprising:
a housing for the components; and
at least three bearings on each side of the housing in contact with an outer surface of the spool.
